(19) United States
(12) Patent Application Publication
(10) Pub. No.: US 2018/0357531 A1
(43) Pub. Date: Dec. 13, 2018

(54) Method for Text Classification and Feature Selection Using Class Vectors and the System Thereof

(71) Applicant: Devanathan GIRIDHARI, Mugalivakkam, Chennai (IN)

(72) Inventors: Devanathan GIRIDHARI, Mugalivakkam, Chennai (IN); Singh Sachan DEVENDRA, Kondapur, Hyderabad (IN); Kumar SHAILESH, Kondapur, Hyderabad (IN)

(21) Appl. No.: 15/778,732

(22) PCT Filed: Aug. 1, 2016
(86) PCT No.: PCT/IN2016/000200

§ 371 Date: May 24, 2018

(30) Foreign Application Priority Data
Nov. 27, 2015 (IN) 6389/CHE/2015

(51) Int. Cl. G06N 3/04; G06K 9/62; G06F 15/18

(52) U.S. Cl. CPC G06N 3/0472; G06F 15/18; G06K 9/6267; G06N 3/0481

(57) ABSTRACT

A method for text classification and feature selection using class vectors, comprising the steps of receiving a text/training corpus including a plurality of training features representing a plurality of objects from a plurality of classes; learning a vector representation for each of the classes along with word vectors in the same embedding space; training the class vectors and words vectors jointly using skip-gram approach; and performing class vector based scoring for a particular feature; and performing feature selection based on class vectors.

### FIELD OF INVENTION

The present invention relates to a method, a system, a processor arrangement and a computer-readable medium for text classification and feature selection. More particularly, the present invention relates to class vectors method wherein the vector representations for each class are learnt which are applied effectively in feature selection tasks. Further, in another aspect, an approach to learn multiple vectors per class is carried out, so that they can represent the different aspects and sub-aspects inherent within the class.

### BACKGROUND ART

Text classification is one of the important tasks in natural language processing. In text classification tasks, the objective is to categorize documents into one or more predefined classes. This finds application in opinion mining and sentiment analysis (e.g. detecting the polarity of reviews, comments or tweets etc.) [Pang and Lee 2008], topic categorization (e.g. aspect classification of web-pages and news articles such as sports, technical etc.) and legal document discovery etc.

In text analysis, supervised machine learning algorithms such as I Bayes (NB) [McCallum and Nigam1998], Logistic Regression (LR) and Support Vector Machine (SVM) [Joachims1998] are used in text classification tasks. The bag of words [Harris1954] approach is commonly used for feature extraction and the features can be either binary presence of terms or term frequency or weighted term frequency. It suffers from data sparsity problem when the size of training data is small but it works remarkably well when size of training data is not an issue and its results are comparable with more complex algorithms [Wang and Manning 2012].

Using the co-occurring words information, we can learn distributed representation of words and phrases [Morin and Bengio 2005] in which each term is represented by a dense vector in embedding space. In the skip-gram model [Mikolov et al. 2013], the objective is to maximize the prediction probability of adjacent surrounding words given current word while global-vectors model [Pennington, Socher, and Manning 2014] minimizes the difference between dot product of word vectors and the logarithm of words co-occurrence probability.

One remarkable property of these vectors is that they learn the semantic relationships between words i.e. in the embedding space, semantically similar words will have higher cosine similarity. For example, the word “cpu” will be more similar to “processor” than to “camera”. To use these word vectors in classification tasks, Le et al. (2014) proposed the Paragraph Vectors approach, in which they learn the vectors representation for documents by stochastic gradient descent and the gradient is computed by back propagation of the error from the word vectors. The document vectors and the word vectors are learned jointly. Kim 2014 demonstrated the application of Convolutional Neural Networks in sentence classification tasks using the pre-trained word embedding's.

In a Prior art a research paper by Matt Taddy at [http://arxiv.org/abs/1504.07295] discloses Document Classification by Inversion of Distributed Language Representations. There have been many recent advances in the structure and measurement of distributed language models: those that map from words to a vector-space that is rich in information about word choice and composition. This vector-space is the distributed language representation. The goal of this note is to point out that any distributed representation can be turned into a classifier through inversion via Bayes rule. The approach is simple and modular, in that it will work with any language representation whose training can be formulated as optimizing a probability model.

In another Prior art a research paper by Quoc Le and Tomas Mikolov at [http://arxiv.org/pdf/1405.4053v2.pdf] discloses Distributed Representations of Sentences and Documents. Many machine learning algorithms require theinput to be represented as a fixed-length featurevector. When it comes to texts, one of the mostcommon fixed-length features is bag-of-words. Despite their popularity, bag-of-words features have two major weaknesses: they lose the ordering of the words and they also ignore semantics of the words. The discloses algorithm represents each document by a dense vector which is trained to predict words in the document. Its construction gives the potential to overcome the weaknesses of bag-of words models. Empirical results show that Paragraph Vectors outperform bag-of-words models as well as other techniques for text representations.

### SUMMARY OF INVENTION

Therefore such as herein described, there is provided class vectors method in which vector representations for each class is learnt. These class vectors are semantically similar to vectors of those words which characterize the class and also give competitive results in document classification tasks. Class Vectors can be applied effectively in feature selection tasks. Therefore it is proposed to learn multiple vectors per class so that they can represent the different aspects and sub-aspects inherent within the class.

As per an embodiment, there is provided distributed representations of words and paragraphs as semantic embedding's in high dimensional data are used across a number of Natural Language Understanding tasks such as retrieval, translation, and classification. Therefore a framework for learning multiple vectors per class in the same embedding space as the word vectors is proposed. Similarity between these class vectors and word vectors are used as features to classify a document to a class. In experiment on several text classification and sentiment analysis tasks, class vectors have shown better or comparable results in classification while learning very meaningful class embedding's.

As per an exemplary embodiment of the present invention, skip gram model is used to learn the vectors in order to maximize the prediction probability of the concurrence of words.

As per another embodiment, each class vectors are represented by its id (class-id) and each class-id co-occurs with every sentence and thus with every word in that class.

According to an exemplary embodiment a method for text classification using class vectors, is disclosed comprising the steps receiving a text including a plurality of training features representing a plurality of objects from a plurality of classes; learning a vector representation for each of the classes along with word vectors in the same embedding space; training the class vectors and words vectors jointly using skip-gram approach; and performing class vector based scoring for a particular feature; and performing feature selection based on class vectors.

According to another exemplary embodiment a system for text classification and feature selection using class vectors, comprising of: a processor arrangement configured for receiving a text including a plurality of training features representing a plurality of objects from a plurality of classes; learning a vector representation for each of the classes along with word vectors in the same embedding space; training the class vectors and words vectors jointly using skip-gram approach; and performing class vector based scoring for a particular feature; performing feature selection based on class vectors; and a storage operably coupled to the processor arrangement for storing a class vector based scoring for a particular feature using the plurality of features selected based on class vectors.

In another exemplary embodiment, there is provided a non-transitory computer-readable medium having computer executable instructions for performing steps of: receiving a text including a plurality of training features representing a plurality of objects from a plurality of classes; learning a vector representation for each of the classes along with word vectors in the same embedding space; training the class vectors and words vectors jointly using skip-gram approach; and performing class vector based scoring for a particular feature; and performing feature selection based on class vectors.

### BRIEF DESCRIPTION OF THE ACCOMPANYING DRAWINGS

FIG. 1 illustrates a class vectors model using skip-gram approach in accordance with the present invention;

FIG. 2 illustrates a graph plot: Expected information vs Realized information using normalized vectors for 1500 most frequent words in Yelp Reviews Corpus in accordance with the present invention.

Table 1 illustrates a dataset summary: Positive Train/Negative Train/Test Set in accordance with the present invention;

Table 2 illustrates a comparison of accuracy scores for different algorithms in accordance with the present invention;

Table 3 illustrates the top 15 similar words to the 5 classes in dbpedia corpus;

Table 4 illustrates the top 15 similar words to the positive class vector and negative class vector in Amazon Electronic Product Reviews;

Table 5 illustrates the top 15 similar words to the positive class vector and negative class vector in Yelp Restaurant Reviews.

### DETAILED DESCRIPTION

To address this and other needs, the present inventors devised method, system and computer readable medium that facilitates classification of text or documents according to a target classification system. The present disclosure provides text classification with improved classification accuracy. The disclosure emphasizes learning of the vectors of model to maximize the prediction probability of the co-occurrence of words. The disclosure also emphasizes on the fact that class vector based scoring for a particular feature is carried out before performing the feature selection based on class.

Prior to initialization of the algorithm, the extended set of keywords and the training corpus are stored on the system. The said learning and execution is implemented by a processor arrangement, for example a computer system. Initially, the method begins by receiving a text including a plurality of training features representing a plurality of objects from a plurality of classes. The learning of the vectors for a particular class is carried out by skip-gram model [Mikolov et al. 2013]. In the skip-gram approach, the parameters of model are learnt to maximize the prediction probability of the co-occurrence of words. Let the words in the corpus be represented as w₁, w₂, w₃, . . . wₙ. The objective function is defined as,

L=Σᵢ₌₁^{N}^{ₛ}Σ_{c∈[-w,w],c=0} log p(w_{i+c}/wᵢ) (1)

where N₈ is the number of words in the sentence(corpus) and L denotes the likelihood of the observed data. Wᵢ denotes the current word, while w_{i+c} is the context word within a window of size w. The prediction probability p(w_{i+c}/w₁) is calculated using the softmax classifier as below,

$$p ( {w}_{i + c} / {w}_{i} ) = \frac{exp ( {v}_{{w}_{i}}^{T} {v}_{{w}_{i + c}}^{′} )}{{\sum }_{w = 1}^{T} exp ( {v}_{{w}_{i}}^{T} {v}_{w}^{′} )} \qquad ( 2 )$$

T is number of unique words selected from corpus in the dictionary, is the vectors representation of the current word from inner layer of neural network while ν [symbol] is the vector representation of the context word from the outer layer of the neural network. In practice, since the size of dictionary can be quite large, the cost of computing the denominator in the above equation can be very expensive and thus gradient update step becomes impractical.

Hierarchical Softmax function is used to speed up training [Morin et al. (2005)]. They construct a binary Huffman tree to compute probability distribution which gives logarithmic speedup log₂(T). Mikolov et al. (2013) proposed negative sampling which approximates log(p(w_{i+c}/wᵢ)) as,

$$log σ ( {v}_{{w}_{i}}^{T} {v}_{{w}_{i + c}}^{′} ) + {\sum }_{j = 1}^{k} \text{?} ( log σ ( - {v}_{{w}_{i}}^{T} {v}_{{w}_{j}}^{′} ) ) \\ \text{?} \text{indicates text missing or illegible when filed} \qquad ( 3 )$$

σ(x) is the sigmoid function, the word wⱼ is sampled from probability distribution over words Pₙ(w). The word vectors are updated by maximizing the likelihood L using stochastic gradient ascent.

Herein disclosed model, as shown in FIG. 1, learns a vector representation for each of the classes along with word vectors in the same embedding space. While training, each class vector is represented by an id. Every word in the sentence of that class co-occurs with its class vector. Class vectors and words vectors are jointly trained using skip-gram approach. Each class vector is represented by its id (class_id). Each class id co-occurs with every sentence and thus with every word in that class. Basically, each class id has a window length of the number of words in that class. We call them as Class Vectors (CV). Following equation (4) new objective function becomes,

Σᵢ₌₁^{N}^{ₛ}Σ_{c∈[-w,w]} [symbol] ₌₀ log p(w [symbol] _{+c}/w [symbol] )+λΣⱼ₌₁^{N}^{_{c}}Σᵢ₌₁^{N}^{ⱼ}logp(wᵢ/cⱼ) (4)

N_{c} is the number of classes, Nⱼ is the number of words in classⱼ, cⱼ, is the class id of the classⱼ. Skip-gram method is used to learn both the word vectors and class vectors.

### Learning Multiple Vectors Per Class

As an example, say, K vectors per class is learnt. This approach considers each word in the documents of the corresponding class and estimates a conditional probability distribution d(x [symbol] /w [symbol] ), conditioned on the current word (wᵢ). A class vector (νₑ [symbol] ) is sampled among the K possible vectors according to this conditional distribution.

$$d ( \text{?} / \text{?} ) = \frac{exp ( \text{?} )}{\text{?} exp ( \text{?} )} \\ \text{?} \text{indicates text missing or illegible when filed} \qquad ( 5 )$$

Where zᵢ is a discrete random variable corresponding to the class vector ν [symbol] is the k^{th} class vector of the j^{th} class. The sampled class vector and the word are then assumed to co-occur with each other and the vectors are learned according to equation (4).

### Class Vector Based Scoring

Converting class vector and word vector similarity to probabilistic score using softmax function is as shown under:

$$\text{?} ( \text{?} / \text{?} ) = \frac{exp ( \text{?} )}{\text{?} exp ( \text{?} )} \\ \text{?} \text{indicates text missing or illegible when filed} \qquad ( 6 )$$

[symbol]

and [symbol] are the inner un-normalised j^{th} class vector and i^{th} word vector respectively.

To predict the class of test data, different ways are used as described below
Summation of probability score is done for all the words in sentence for each class and predict the class with the maximum score. (CV Score)

$$\text{?} log ( \text{?} ( \text{?} / \text{?} ) ) \\ \text{?} \text{indicates text missing or illegible when filed} \qquad ( 7 )$$

Difference of the probability score of the class vectors is taken and used as features in the bag of words model followed by Logistic Regression classifier. For example, in the case of sentiment analysis, the two class are positive and negative. So, the expression becomes, (CV-LR)

f(w)=log(s(w/c [symbol] ))−log(a(w/c [symbol] )) (8)

w is the matrix vector of the words in vocabulary.
The similarity between class vectors and word vectors is computed after normalizing them by their 12-norm and using the difference between the similarity score as features in bag of words model. (norm CV-LR)
In order to extend the above approach for multiclass and multilabel classification, feature vector f(w;c_{f}) for each class is constructed. For class 1, the expression becomes,

f(w;c [symbol] )=ν [symbol] −min( [symbol] ). (10)

In case of multiple vectors per class, the maximum of the first term is taken in above equation while the second term remains the same. Equation (8) can be extended for multilabel classification in similar way.

### Feature Selection

Important features in the corpus can be selected by information theoretic criteria such as conditional entropy and mutual information. The entropy of the class is assumed to be maximum i.e. HI=1 irrespective of the number of documents in each class. Realized information of class given a feature wᵢ is defined as,

I(C;w=wᵢ)=H(C)−H(C/w=wₗ) (11)

where conditional entropy of class H(C/wᵢ), is,

$$\begin{matrix} H ( C / w = {w}_{i} ) = - \text{?} p ( {c}_{i} / {w}_{i} ) {log}_{2} p ( {c}_{i} / {w}_{i} ) \\ \text{?} \text{indicates text missing or illegible when filed} & ( 12 ) \\ p ( {c}_{i} / {w}_{i} ) = \frac{exp ( {v}_{{c}_{i}}^{T} {v}_{{w}_{i}} )}{\text{?} exp ( {v}_{{c}_{i}}^{T} {v}_{{w}_{i}} )} \\ \text{?} \text{indicates text missing or illegible when filed} & ( 13 )\end{matrix}$$

We calculate expected information I(C;w) also called mutual information for each word as,

I(C;w)=H(C)−Σ_{w}p(w)H(C/w) (14)

p(w) is calculated from the document frequency of word. The expected information vs realized information is plotted on a graph as shown in FIG. 2, to see the important features in the dataset.

### Dataset Description

Experiments on Amazon Electronic Reviews, Yelp Restaurant Reviews and Dbpedia Ontology dataset are carried out for the purposes of testing. In reviews dataset, the task is to do sentiment classification among 2 classes (i.e. each review can belong to either positive class or negative class) while in Dbpedia dataset, the task is to do topic classification among 14 classes.
Amazon Electronic Product reviews—¹http:// [symbol] .com/ [symbol] data.html This dataset is a part of large Amazon reviews dataset by McAuley et al. (2013). ¹http://snap.standford.edu/data/wed-Amazon.html. This dataset [Johnson and Zhang 2015] contains training set of 392K reviews split into various various sizes and a test set of 25K reviews. We pre-process the data by converting the text to lowercase and removing some punctuation characters.
Yelp Reviews corpus [³https://www.kaggle.com/c/yel-recruiting/data]—This reviews dataset was provided by Yelp as a part of Kaggle competition. Each review contains star rating from 1 to 5. Following the generation of above Amazon Electronic Product Reviews data, we considered ratings 1 and 2 as negative class and 4 and 5 as positive class. We separated the files into ratings and do pre-processing of the corpus. ¹We use the code available at https://github.com/TaddyLab/d [symbol] /blob/master/ [symbol] / [symbol] .PY, [Taddy 2015] In this way, we obtain around 193K reviews for training and around 20K reviews for testing.
Dbpedia Ontology dataset [https:// [symbol] ]—This dataset is a part of Dbpedia project (2014) which extracts structured content from the information in Wikipedia. This dataset (2015) contains 14 classes. Each class has 40K examples in training set and 5K test examples. Each example contains title and abstract from the corresponding Wikipedia article. We pre-process the data by removing non-English and not printable characters and correcting some punctuation characters.

TABLE 1
Dataset summary

| Dataset | Pos Train | Neg Train | Test Set |
|---|---|---|---|
| Amazon | 196000 | 196000 | 25000 |
| Yelp | 154506 | 38172 | 19931 |

| | | |
|---|---|---|
| Dbpedia | 560000 | 70000 |

### Experiments

Sentence segmentation is done in the corpus following the approach of Kiss et al. (2006) as implemented in NLTK library (Loper and Bird 2002). Phrase identification is carried out in the data by two sequential iterations using the approach as described in Kumar et al. (2014). The top important phrases are selected according to their frequency and coherence and annotate the corpus with phrases. To do experiments and train the models, and those words whose frequency is greater than 5 are considered. The said common setup is used for all the experiments.

The experiments are done with following methods. In the bag of words (bow) approach in which annotation of the corpus is done with phrases as mentioned earlier. The best results are reported among the bag of words in table 2. In the bag of words method, the features are extracted by using:

1. presence/absence of words (binary)
2. term frequency of the words (tf)
3. inverse document frequency of words (idf)
4. product of term frequency and inverse document frequency of words (tf−idf)

Further some of the recent state of the art methods are evaluated for text classification on the above datasets

1. I Bayes features in bag of words followed by Logistic Regression (NB-LR) [Wang and Manning 2012]. In this, multinomial I Bayes model is learned for each of the classes and the difference of the coefficients is used as feature vector representation for a document to train a classifier. This is applicable to only binary classification tasks.
2. Inversion of distributed language representation (W2V inversion) [Taddy 2015], in which the approach is to learn a separate embedding representation of each category using skipgram modelling by hierarchical softmax and the probability score of a test document is computed using equation (?) for each of its sentences.
3. Paragraph Vectors—Distributed Bag of Words Model (PV-DBOW) [Le and Mikolov 2014]. In this, every document is represented by its id which co-occurs with each word in the document. The corresponding vector representation of the document id is learnt jointly with word vectors and is used as its feature vector representation to train the classifier.

Class Vectors method based scoring and feature extraction. We extend the open-source code [https://code.google.com/p/word2vec/] to implement the class vectors approach. We learn the class vectors and word embeddings using these hyper parameter settings (window=10, negative=5, min_count=5, sample=1e-3, hs=1, iterations=40, [symbol] =1). We use one vector per class for amazon and yelp data-sets while two vectors per class for dbpedia corpus. For prediction, we experiment with the three approaches as mentioned above.

After the features are extracted, Logistic Regression classifier is trained in scikit-learn [Pedregosa et al. 2011] to compute the results. Results of our model and other models are listed in table 2. FIG. 2: Expected information vs Realized information using normalized vectors for 1500 most frequent words in Yelp Reviews Corpus

TABLE 2
Comparison of accuracy scores for different algorithms

| Model | Amazon | Yelp | Dbpedia |
|---|---|---|---|
| bow binary | 91.29 | 92.48 | 98.12 |
| bowtf | 90.49 | 91.45 | 98.19 |
| bowidf | 92.00 | 93.98 | 98.30 |
| bowtf-idf | 91.76 | 93.46 | 98.36 |
| I Bayes | 86.25 | 89.77 | 95.93 |
| NB-LR | 91.49 | 94.68 | — |
| W2V Inversion | 87.1 | 93.3 | 97.1 |
| PV-DBOW | 90.07 | 92.86 | 94.13 |
| CV Score | 84.06 | 87.85 | |
| norm CV-LR | 91.58 | 94.91 | 98.41 |
| CV-LR | 91.70 | 94.83 | 95.03 |

### Results

1. From the aforesaid discussion and experimental results, it was found that annotating the corpus by phrases is important to give better results. For example, the accuracy of PV-DBOW method on Yelp Reviews increased from 89.67% (without phrases) to 92.86% (with phrases) which is more than 3% increase in accuracy.
2. The class vectors have high cosine similarity with words which discriminate between classes. For example, when trained on Yelp reviews, positive class vector was similar to words like “very_very_good”, “fantastic” while negative class vector was similar to words like “awful”, “terrible” etc. More results can be seen in Table 3, Table 4 and Table 5.
3. In addition, multiple vectors of a class may correspond to different concepts in that category. In Table 3, 2 vectors of Village class from Dbpedia corpus is shown. Each vector shows high similarity with names of different villages.
4. With reference to FIG. 2, it can be inferred that the class informative words have greater values of both expected information and realized information. One advantage of class vectors based feature selection method over document frequency based method is that low frequency words can have high mutual information value. Under Yelp reviews dataset, it was found that the class vectors based approach (CV-LR and norm CV-LR) performs much better than normalized term frequency (tf), tf−idf weighted bag of words, paragraph vectors and W2V inversion and it achieves competitive results in sentiment classification. In the Amazon reviews dataset, the bow idf performs surprisingly well and outperforms all other methods. Further in Dbpedia ontology dataset, the categories are not really mutually exclusive. The prediction of labels is considered as multi-label prediction problem. Top two labels per test document are predicted when the probabilities of both these labels is very high and take the best one. The shuffling of the corpus is important to learn high quality class vectors. When learning the class vectors using only the data of that class, we find that class vectors lose their discriminating power. So, it is important to jointly learn the model using full dataset.

Therefore, it has been experimentally proven that class vectors and its similarity with words in vocabulary as features effectively in text categorization tasks can be effectively used in text classification. The feature selection can be carried out using the similarity of word vectors with class vectors. The multiple vectors per class can represent the diverse aspects and sub-aspects in that class. The bag of words based approaches perform remarkably well in topic categorization tasks as per the study made above. In order to use more than 1-gram as features approaches to compute the embeddings of n-grams from the composition of its uni-grams is needed. Recursive Neural Networks of Socher et al. 2013 can be applied in these cases. Generative models of class based on word embedding's and its application in text clustering and text classification is illustrated.

TABLE 3
Top 15 similar words to the 5 classes in dbpedia corpus.
Two class vectors are trained for village category while
one class vector for other categories.
DBPedia Corpus
Top Similar Words to

| Building | Album | Company | Athlete | Village.1 | Village.2 |
|---|---|---|---|---|---|
| Class | Class | Class | Class | Class | Class |
| historic | album | company | football | village | village |
| building | EP | LLC | player | silifke | susz |
| mansion | compilation | multinational | soccer | mersin | biay |
| apartments | remix | corporation | retired | anamur | dbno |
| residents | self-titled | headquartered | professional | census | barciany |
| redbrick | studio | subsidiary | coached | glnar | tykocin |
| complex | acoustic | Inc | teammate | srebrenik | czuchw |
| cemetery | Livin | US-based | goalkeeper | mut | nowogrd |
| hotel | major-label | distributor | snooker | chef-lieu | sicienko |
| farmstead | self-released | NASDAQ | league | bozyaz | olszanka |
| gatehouse | mini-album | Networks | basketball | erdemli | czarna |
| cottage | NOFX | telecommunications | golfer | rogatica | sulejw |
| housed | Ramones | majority- | referee | babunica | korsze |
| | | owned | | | |
| inn | Hits | Investments | swimmer | babice | wielowie |
| courthouse | Songs | branded | boxer | subdistrict | gniewino |

TABLE 4
Top 15 similar words to the positive class vector and
negative class vector.
Amazon Electronic Product Review's
Top similar words to

| Pos Class Vector | Neg Class Vector |
|---|---|
| very_pleased | unfortunately |
| product_works_great | very_disappointed |
| awesome | piece_of_crap |
| more_than_i_expected | piece_of_garbage |
| very_satisfied | hunk_of_junk |
| great_buy | awful |
| service_so_good | even_worse |
| great_product | sadly |
| very_happy | worthless |
| am_very_pleased | terrible |
| a_great_value | useless |
| it_works_great | never_worked |
| works_like_a_charm | horrible |
| great_purchase | terrible_product |
| fantastic | wasted_my_money |

TABLE 5
Yelp Restaurant Reviews
Top Similar words to

| Pos Class Vector | Neg Class Vector |
|---|---|
| very_very_good | awful |
| fantastic | terrible |
| awesome | horrible |
| amaz | fine_but |
| very_yummy | food_wa_cold |
| great_too | awful_service |
| excellent | horrib |
| real_good | not_very_good |
| spot_on | pathetic |
| food_wa_fantastic | tastele |
| very_good_too | mediocre_at_best |
| love_thi_place | unacceptable |
| food_wa_awesome | disgust |
| very_good | food_wa_bland |
| great | crappy_service |

### Operating Environment

As pen an embodiment, the invention can be performed over a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations. The invention may also be practiced in distributed computing environments where tasks are performed by remote processing devices that are linked through a communications network. In a distributed computing environment, program modules may be located in local and/or remote computer storage media including memory storage devices.

The computer system may include a variety of computer-readable media. Computer-readable media can be any available media that can be accessed by the computer system and includes both volatile and 17reebank17ile media. The system memory includes computer storage media in the form of volatile and/or 17reebank17ile memory such as read only memory (ROM) and random access memory (RAM). A basic input/output system (BIOS), containing the basic routines that help to transfer information between elements within computer system, such as during start-up, is typically stored in ROM. Additionally, RAM may contain operating system, application programs, other executable code and program data.

### REFERENCES

[Harris 1954] Zellig Harris. 1954. Distributional struc-ture. Word, 10(23):146-162.
[Joachims1998] Thorsten Joachims. 1998. Text cat-egorization with 17reeban vector machines: Learning with many relevant features. In Proceedings of the 10^{th} European Conference on Machine Learn-ing, ECML '98, pages 137-142, London, UK, UK. Springer-Verlag.
[Johnson and Zhang2015] Rie Johnson and Tong Zhang. 2015. Effective use of word order for text categorization with convolutional neural networks. In Proceedings of the 2015 Conference of the North American Chapter of the Association for Computational Linguistics: Human Language Technologies, pages 103-112, Denver, Colo., May-June. Association for Computational Linguistics.
[Kim2014] Yoon Kim. 2014. Convolutional neu-ral networks for sentence classification. CoRR, abs/1408.5882.
[Kumar2014] S. Kumar. 2014. Phrase identification in a sequence of words, November 18. U.S. Pat. No. 8,892,422.
[Le and Mikolov2014] Quoc V. Le and Tomas Mikolov. 2014. Distributed representations of sentences and documents. In Proceedings of the 31 stlnterna-tional Conference on Machine Learning.
[McAuley and Leskovec2013] J. J. McAuley and J. Leskovec. 2013. Hidden factors and hidden topics: understanding rating dimensions with review text. In Recommender Systems.
[McCallum and Nigam1998] Andrew McCallum and Kamal Nigam. 1998. A comparison of event models for Ibayes text classification.
[Mikolovet al. 2013] Tomas Mikolov, IlyaSutskever, Kai Chen, Greg S. Corrado, and Jeff Dean. 2013. Distributed representations of words and phrases and their compositionality. In Advances in Neural Information Processing Systems, pages 3111-3119.
[Morin and Bengio2005] Frederic Morin and YoshuaBengio. 2005. Hierarchical probabilistic neural net-work language model. In Proceedings of the In-ternational Workshop on Artificial Intelligence and Statistics, pages 246-252.
[Pang and Lee2008] Bo Pang and Lillian Lee. 2008. Opinion Mining and Sentiment Analysis. Founda-tions and Trends in Information Retrieval, 1-2:1-135.
[Pedregosact al. 2011] F. Pedregosa, G. Varoquaux, A. Gramfort, V. Michel, B. Thirion, O. Grisel, M. Blondel, P. Prettenhofer, R. Weiss, V. Dubourg, J. Vanderplas, A. Passos, D. Cournapeau, M. Brucher, M. Perrot, and E. Duchesnay. 2011. Scikit-learn: Machine learning in Python. Journal of Machine Learning Research, 12:2825-2830.
[Pennington et al. 2014] Jeffrey Pennington, Richard Socher, and Christopher Manning. 2014. Glove: Global vectors for word representation. In Proceed-ings of the 2014 Conference on Empirical Methods in Natural Language Processing (EMNLP), pages 1532-1543, Doha, Qatar, October. Association for Computational Linguistics.
[R ̆ehuº ̆rek and Sojka2010] Radim R ̆ehuº ̆rek and Petr So-jka. 2010. Software Framework for Topic Modelling with Large Corpora. In Proceed-ings of the LREC 2010 Workshop on New Chal-lenges for NLP Frameworks, pages 45-50, Val-letta, Malta, May. ELRA. http://is.muni. Cz/publication/884893/en.
[Socheret al. 2013] Richard Socher, Alex Perelygin, Jean Y. Wu, Jason Chuang, Christopher D. Manning, Andrew Y. Ng, and Christopher Potts. 2013. Recur-sive deep models for semantic compositionality over a sentiment 19reebank. In Proceedings of the confer-ence on empirical methods in natural language pro-cessing (EMNLP), volume 1631, page 1642.
[Taddy2015] Matt Taddy. 2015. Document classifica-tion by inversion of distributed language representa-tions. In Proceedings of the 53^{rd} Annual Meeting of the Association for Computational Linguistics.
[Wang and Manning2012] Sida I. Wang and Christo-pher D. Manning. 2012. Baselines and bigrams: Simple, good sentiment and topic classification. In Proceedings of the ACL, pages 90-94.

Although the foregoing description of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

1. A method for text classification and feature selection using class vectors, comprising the steps of:
receiving a text/training corpus including a plurality of training features representing a plurality of objects from a plurality of classes;
learning a vector representation for each of the classes along with word vectors in the same embedding space;
training the class vectors and words vectors jointly using skip-gram approach;
and performing class vector based scoring for a particular feature; and
performing feature selection based on class vectors.

2. The method for text classification using class vectors as claimed in claim 1, wherein under the skip-gram approach, the parameters of model are learnt to maximize the prediction probability of the co-occurrence of words vide function:
$$L = \text{?} log p ( \text{?} / \text{?} ) \\ \text{?} \text{indicates text missing or illegible when filed} \qquad ( 1 )$$
where corpus is represented as [symbol] ;
N₈ is the number of words in the sentence(corpus);
L denotes the likelihood of the observed data; and
wᵢ denotes the current word, while w_{i+c} is the context word within a window of size w.

3. The method for text classification using class vectors as claimed in claim 1, wherein the prediction probability [symbol] is calculated using the softmax classifier as:
$$p ( \text{?} / \text{?} ) = \frac{exp ( \text{?} )}{\text{?} exp ( \text{?} )} \\ \text{?} \text{indicates text missing or illegible when filed} \qquad ( 2 )$$
where T is number of unique words selected from corpus in the dictionary; and [symbol]
is the vector representation of the context word.

4. The method for text classification using class vectors as claimed in claim 1, wherein Hierarchical Softmax function is used to speed up training by constructing a binary Huffman tree to compute probability distribution which gives logarithmic speedup [symbol] .

5. The method for text classification using class vectors as claimed in claim 1, wherein the negative sampling which approximates [symbol] is carried out using formula:
$$log σ ( \text{?} ) + \text{?} ( log σ ( \text{?} ) ) \\ \text{?} \text{indicates text missing or illegible when filed} \qquad ( 3 )$$
where [symbol] is the sigmoid function and the word w is sampled from probability distribution over words [symbol] .

6. The method for text classification using class vectors as claimed in claim 1, wherein the word vectors are updated by maximizing the likelihood (L) using stochastic gradient ascent.

7. The method for text classification using class vectors as claimed in claim 1, wherein during the training, each class vector is represented by an id and every word in the sentence of that class co-occurs with its class vector.

8. The method for text classification using class vectors as claimed in claim 7, wherein each class id has a window length of the number of words in that class with objective function as,
$$\text{?} log p ( \text{?} / \text{?} ) + λ \text{?} log p ( \text{?} / \text{?} ) \\ \text{?} \text{indicates text missing or illegible when filed} \qquad ( 4 )$$
Where N_{c} is the number of classes, Nⱼ is the number of words in classⱼ, cⱼ is the class id of the classⱼ.

9. The method for text classification using class vectors as claimed in claim 1, wherein the learning of multiple vectors per class includes considering of each word in the documents of the corresponding class followed by estimating a conditional probability distribution [symbol] conditioned on the current word (wᵢ).

10. The method for text classification using class vectors as claimed in claim 1, wherein class vector ( [symbol] ) is sampled among the K possible vectors according conditional distribution as:
$$d ( \text{?} / \text{?} ) = \frac{exp ( \text{?} )}{\text{?} exp ( \text{?} )} \\ \text{?} \text{indicates text missing or illegible when filed} \qquad ( 5 )$$
where zᵢ is a discrete random variable corresponding to the class vector [symbol] is the k^{th} class vector of the j^{th} class.

11. The method for text classification using class vectors as claimed in claim 1, wherein the conversion of class vector and word vector similarity to probabilistic score using softmax function as:
$$\text{?} ( \text{?} / \text{?} ) = \frac{exp ( \text{?} )}{\text{?} exp ( \text{?} )} \\ \text{?} \text{indicates text missing or illegible when filed} \qquad ( 6 )$$
where [symbol] are the inner un-normalized j^{th} class vector and i^{th} word vector respectively.

12. The method for text classification using class vectors as claimed in claim 1, wherein the prediction for the class of test data include step of:
performing summation of probability score is done for all the words in sentence for each class and predict the class with the maximum score (CV Score) as
$$\text{?} log ( \text{?} ( \text{?} / \text{?} ) ) \\ \text{?} \text{indicates text missing or illegible when filed} \qquad ( 7 )$$

13. The method for text classification using class vectors as claimed in claim 1, wherein the prediction for the class of test data include step of:
calculating the difference of the probability score of the class vectors and Logistic Regression classifier (CV-LR) as:
f(w)=log( [symbol] (w/ [symbol] ))−log( [symbol] ( [symbol] / [symbol] )) (8)
where “w” is the matrix vector of the words in vocabulary.

14. The method for text classification using class vectors as claimed in claim 1, wherein the similarity between class vectors and word vectors is computed after normalizing them by their/2-norm and using the difference between the similarity score as features in bag of words model (norm CV-LR).

15. The method for text classification using class vectors as claimed in claim 1, wherein in order to extend the approach for multiclass and multilabel classification, feature vector [symbol] for each class is constructed and for class 1, the expression becomes,
f(w [symbol] )= [symbol] −min(ν [symbol] ) (10)

16. The method for text classification using class vectors as claimed in claim 1, wherein the feature selection in the corpus is selected by information theoretic criteria such as conditional entropy and mutual information/(C;w) for each word as
I(C;w)=H(C)−Σ_{w}p(w)H(C/w)
where p(w) is calculated from the document frequency of word.

17. A system for text classification and feature selection using class vectors, comprising of:
a processor arrangement configured for receiving a text including a plurality of training features representing a plurality of objects from a plurality of classes;
learning a vector representation for each of the classes along with word vectors in the same embedding space;
training the class vectors and words vectors jointly using skip-gram approach;
and performing class vector based scoring for a particular feature;
performing feature selection based on class vectors; and
a storage operably coupled to the processor arrangement for storing a class vector based scoring for a particular feature using the plurality of features selected based on class vectors.

18. The system for text classification using class vectors as claimed in claim 17, wherein under the skip-gram approach, the parameters of model are learnt to maximize the prediction probability of the co-occurrence of words vide function:
$$L = \text{?} log p ( \text{?} / \text{?} ) \\ \text{?} \text{indicates text missing or illegible when filed} \qquad ( 1 )$$
where corpus is represented as [symbol] ;
N₈ is the number of words in the sentence(corpus);
L denotes the likelihood of the observed data; and
wᵢ denotes the current word, while w_{i+c} is the context word within a window of size w.

19. The system for text classification using class vectors as claimed in claim 18, wherein the prediction probability [symbol] is calculated using the softmax classifier as:
$$p ( \text{?} / \text{?} ) = \frac{exp ( \text{?} )}{\text{?} exp ( \text{?} )} \\ \text{?} \text{indicates text missing or illegible when filed} \qquad ( 2 )$$
where T is number of unique words selected from corpus in the dictionary; and [symbol]
is the vector representation of the context word.

20. The system for text classification using class vectors as claimed in claim 17, wherein Hierarchical Softmax function is used to speed up training by constructing a binary Huffman tree to compute probability distribution which gives logarithmic speedup [symbol] .

21. The system for text classification using class vectors as claimed in claim 17, wherein the negative sampling which approximates w<, is carried out using formula:
$$log σ ( \text{?} ) + \text{?} ( log σ ( \text{?} ) ) \\ \text{?} \text{indicates text missing or illegible when filed} \qquad ( 3 )$$
where [symbol] is the sigmoid function and the word wⱼ is sampled from probability distribution over words [symbol] .

22. The system for text classification using class vectors as claimed in claim 17, wherein the word vectors are updated by maximizing the likelihood (L) using stochastic gradient ascent.

23. The system for text classification using class vectors as claimed in claim 17, wherein during the training, each class vector is represented by an id and every word in the sentence of that class co-occurs with its class vector.

24. The system for text classification using class vectors as claimed in claim 23, wherein each class id has a window length of the number of words in that class with objective function as,
$$\text{?} log p ( \text{?} / \text{?} ) + λ \text{?} log p ( \text{?} / \text{?} ) \\ \text{?} \text{indicates text missing or illegible when filed} \qquad ( 4 )$$
where N_{c} is the number of classes, Nⱼ is the number of words in classⱼ, cⱼ is the class id of the classⱼ.

25. The system for text classification using class vectors as claimed in claim 17, wherein the learning of multiple vectors per class includes considering of each word in the documents of the corresponding class followed by estimating a conditional probability distribution [symbol] , conditioned on the current word (wᵢ).

26. The system for text classification using class vectors as claimed in claim 17, wherein class vector ( [symbol] ) is sampled among the K possible vectors according conditional distribution as:
$$d ( \text{?} / \text{?} ) = \frac{exp ( \text{?} )}{\text{?} exp ( \text{?} )} \\ \text{?} \text{indicates text missing or illegible when filed} \qquad ( 5 )$$
where zᵢ is a discrete random variable corresponding to the class vector [symbol] is the k^{th} class vector of the j^{th} class.

27. The system for text classification using class vectors as claimed in claim 17, wherein the conversion of class vector and word vector similarity to probabilistic score using softmax function as:
$$\text{?} ( \text{?} / \text{?} ) = \frac{exp ( \text{?} )}{\text{?} exp ( \text{?} )} \\ \text{?} \text{indicates text missing or illegible when filed} \qquad ( 6 )$$
where [symbol] are the inner un-normalized j^{th} class vector and i^{th} word vector respectively.

28. The system for text classification using class vectors as claimed in claim 17, wherein the prediction for the class of test data includes step of:
performing summation of probability score is done for all the words in sentence for each class and predict the class with the maximum score (CV Score) as
$$\text{?} log ( \text{?} ( \text{?} / \text{?} ) ) \\ \text{?} \text{indicates text missing or illegible when filed} \qquad ( 7 )$$

29. The system for text classification using class vectors as claimed in claim 17, wherein the prediction for the class of test data include step of:
calculating the difference of the probability score of the class vectors and Logistic Regression classifier (CV-LR) as:
f(w)=log( [symbol] ))−log( [symbol] )) (8)
where “w” is the matrix vector of the words in vocabulary.

30. The system for text classification using class vectors as claimed in claim 17, wherein the similarity between class vectors and word vectors is computed after normalizing them by their/2-norm and using the difference between the similarity score as features in bag of words model (norm CV-LR).

31. The system for text classification using class vectors as claimed in claim 17, wherein in order to extend the approach for multiclass and multilabel classification, feature vector [symbol] for each class is constructed and for class 1, the expression becomes,
f( [symbol] )= [symbol] −min( [symbol] ) (10)

32. The system for text classification using class vectors as claimed in claim 17, wherein the feature selection in the corpus is selected by information theoretic criteria such as conditional entropy and mutual information/(C;w) for each word as
I(C;w)=H(C)−Σ_{w}p(w)H(C/w)
where p(w) is calculated from the document frequency of word.

33. A non-transitory computer-readable medium having computer executable instructions for performing steps of:
receiving a text including a plurality of training features representing a plurality of objects from a plurality of classes;
learning a vector representation for each of the classes along with word vectors in the same embedding space;
training the class vectors and words vectors jointly using skip-gram approach;
and performing class vector based scoring for a particular feature; and
performing feature selection based on class vectors.
